(19) United States
(12) Patent Application Publication
(10) Pub. No.: US 2007/0096638 A1
(43) Pub. Date: May 3, 2007

(54) Electroluminescent compounds from binuclear, trinuclear, oligonuclear, and/or polynuclear metal complexes

(75) Inventors: Herbert Friedrich Boerner, AACHEN (DE); Helga Hummel, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/578,651

(22) PCT Filed: Nov. 4, 2004
(86) PCT No.: PCT/IB04/52302

§ 371 Date: May 9, 2006

(30) Foreign Application Priority Data
Nov. 13, 2003 (EP) 03104180.9

(51) Int. Cl. H01J 1/62; C07F 5/00

(52) U.S. Cl. 313/504; 534/15

(57) ABSTRACT

This invention relates to electroluminescent compounds and in particular to electroluminescent compounds used in organic LED's (OLEDs).

Electroluminescent compounds from binuclear, trinuclear, oligonuclear, and/or polynuclear metal complexes.

OLEDs usually comprise metal complexes, in which a central metal atom is coordinated by or bound to one or more suitable ligand. A widely used metal complex is for example:

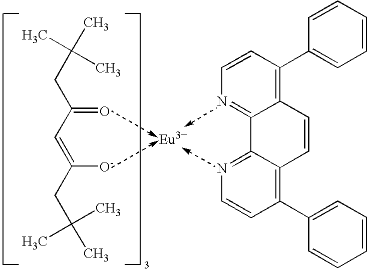

The luminescence in OLEDs is usually accomplished in that there are certain molecules present, which have hole transporting properties, and other molecules, which have electron transporting properties. These molecules are usually organic molecules. By recombination of a hole and an electron, suitable molecules are transferred to excited states, which are transferred to the metals bound in the metal complexes. These metals then undergo fluorescence and emit light.

In suitable complexes, which contain e.g. Europium and Terbium as central metals, photolumniscence yields as much as 75% could be found. However, when these complexes were used in OLEDs, the luminescence yield dropped dramatically.

The inventors have studies these phenomena carefully and have come to the conclusion, that in OLEDs not all available complexes are excited. Furthermore, the possibility that a complex, in which the metal is already in the excited state, is excited once more, is rather high. The central metal atom in this complex is then transferred to a further excited state and the wanted fluorescence or luminescence does not take place.

It is therefore an object of the present invention to provide an electroluminescent compound, which is suitable of having a higher photoluminescence, and an electroluminescent device having such an electroluminescent compound and a lighting unit having such an electroluminescent device.

This object is achieved by an electroluminescent compound with the features of claim 1, an electroluminescent device with the features of claim 9 and a lighting unit with the features of claim 10.

According to the present invention, an electroluminescent compound is provided, which is selected from binuclear, trinuclear, oligonuclear, and/or polynuclear complexes of metals comprising at least one bridging ligand which is bound and/or coordinated to at least two of said metals, whereby at least one of said ligands is fully-conjugated at least between the binding and/or coordination sites of said metals.

If an electroluminescent compound according to the present invention is excited, a transfer to one of the metal atoms takes place, as known in the state of the art. However, if a further excitation takes place, this excited metal atom is not excited once more, rather a transfer to a further metal atom present in the electroluminescent compound takes place, so that two excited metal atoms are present in the compound. To this end, there is provided at least one bridging ligand which is bound and/or coordinated to at least two of said metals and is fully-conjugated at least between the binding and/or coordination sites of said metals. By this conjugation, there can be an energy transfer to a second or third or further metal atom, when a metal atom with an excited state is already present in the complex.

Complexes having two or more metal atoms to be used in electroluminescent devices are known from the WO 03/14256 A1. However, the bridging ligands between the two or more metals are not fully conjugated, so that an energy transfer is not possible.

Metals which can be used as complexed metals in the present invention, are for example B, Al, Si, alkali metals, earth alkali metals, transition metals, such as Fe, Co, Ni, Ru, Rh, Pt, Os, Ir, Re, Ag, Cu, Au, Hg, Cd, Nb, Zr, Ta. However, in a preferred embodiment of the present invention, the metals are rare earth metals, preferably selected from the group comprising La, Ce, Pr, Nd, Pm, Sm, Eu, Gd, Th, Dy, Ho, Er, Tm, Yb, Lu.

The metals present in the electroluminescent compound according to the present invention may be different from each other. However, according to a preferred embodiment, the metals are identical. By this way, only one wavelength of fluorescence is provided, therefore obtaining a higher luminescence yield and a better control of the emitted wavelength.

Generic group definition: Throughout the description and claims generic groups have been used, for example alkyl, alkoxy, aryl. Unless otherwise specified the following are preferred groups that may be applied to generic groups found within compounds disclosed herein:

alkyl: linear and branched C₁-C₈-alkyl such as methyl, ethyl, n-propyl, iso-propyl, n-butyl, sec-butyl, tert-butyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl or 1-ethyl-2-methylpropyl, n-heptyl or n-octyl,

alkenyl: C₂-C₆-alkenyl such as ethenyl; prop-2-en-1-yl; n-buten-4-yl; 1-methylprop-2-en-1-yl; 2-methylprop-2-en-1-yl; 2-buten-1-yl; n-penten-3-yl; n-penten-4-yl; 1-methylbut-2-en-1-yl; 2-methylbut-2-en-1-yl; 3-methylbut-2-en-1-yl; 1-methylbut-3-en-1-yl; 2-methylbut-3-en-1-yl; 3-methylbut-3-en-1-yl; 1,1-dimethylprop-2-en-1-yl; 1,2-dimethylprop-2-en-1-yl; 1-ethylprop-2-en-1-yl; n-hex-3-en-1-yl; n-hex-4-en-1-yl; n-hex-5-en-1-yl; 1-methylpent-3-en-1-yl; 2-methylpent-3-en-1-yl; 3-methylpent-3-en-1-yl; 4-methylpent-3-en-1-yl; 1-methylpent-4-en-1-yl; 2-methylpent-4-en-1-yl; 3-methylpent-4-en-1-yl; 4-methylpent-4-en-1-yl; 1,1-dimethylbut-2-en-1-yl; 1,1-dimethylbut-3-en-1-yl; 1,2-dimethylbut-2-en-1-yl; 1,2-dimethylbut-3-en-1-yl; 1,3-dimethylbut-2-en-1-yl; 1,3-dimethylbut-3-en-1-yl; 2,2-dimethylbut-3-en-1-yl; 2,3-dimethylbut-2-en-1-yl; 2,3-dimethylbut-3-en-1-yl; 3,3-dimethylbut-2-en-1-yl; 1-ethylbut-2-en-1-yl; 1-ethylbut-3-en-1-yl; 2-ethylbut-2-en-1-yl; 2-ethylbut-3-en-1-yl; 1,1,2-trimethylprop-2-en-1-yl; 1-ethyl-1-methylprop-2-en-1-yl or 1-ethyl-2-methylprop-2-en-1-yl,

conjugated polyene: aliphatic or cycloaliphatic compounds that comprise two or more conjugated double bonds such as 1,3-butadiene-1-yl; 1,3-butadiene-1,4-diyl, 2-methyl-1,3-butadiene-1-yl or 2-methyl-1,3-butadiene-1,4-diyl,

cycloalkyl: C₃-C₈-cycloalkyl such as cyclopropyl; cyclobutyl;

cyclopentyl; cyclohexyl; cycloheptyl; cyclooctyl,

alkylene: C₁-C₆ alkylenes such as methylene; 1,1-ethylene; 1,2-ethylene; 1,1-propylene; 1,2-propylene; 1,3-propylene; 2,2-propylene; 2,3-butylene; 1,4-butylene; cyclohex-1-en-1,2-diyl,

alkynyl: C₁-C₆ alkynyls such as ethynyl; prop-1-yn-1-yl; prop-2-yn-1-yl; n-but-1-yn-1-yl; n-but-1-yn-3-yl; n-but-1-yn-4-yl; n-but-2-yn-1-yl; n-pent-1-yn-1-yl; n-pent-1-yn-3-yl; n-pent-1-yn-4-yl; n-pent-1-yn-5-yl; n-pent-2-yn-1-yl; n-pent-2-yn-4-yl; n-pent-2-yn-5-yl; 3-methylbut-1-yn-3-yl; 3-methylbut-1-yn-4-yl; n-hex-1-yn-1-yl; n-hex-1-yn-3-yl; n-hex-1-yn-4-yl; n-hex-1-yn-5-yl; n-hex-1-yn-6-yl; n-hex-2-yn-1-yl; n-hex-2-yn-4-yl; n-hex-2-yn-5-yl; n-hex-2-yn-6-yl; n-hex-3-yn-1-yl; n-hex-3-yn-2-yl; 3-methylpent-1-yn-1-yl; 3-methylpent-1-yn-3-yl; 3-methylpent-1-yn-4-yl; 3-methylpent-1-yn-5-yl; 4-methylpent-1-yn-1-yl; 4-methylpent-2-yn-4-yl or 4-methylpent-2-yn-5-yl,

alkynylene: C₂-C₆ alkynylenes such as —C≡C—, —CH₂—C≡C—; —CH(CH₃)—C≡C— or —C≡C—CH(C₂H₅)CH₂—,

aryl: selected from homoaromatic compounds having a molecular weight under 300 such as phenyl; biphenyl; α-naphthyl; β-naphthyl; tolyl; xylyl; mesityl; naphthacenyl; anthracenyl or phenanthrenyl,

arylene: bivalent aromatic compound such as benzene-1,2-diyl; benzene-1,3-diyl; benzene-1,4-diyl; naphthalene-1,2-diyl; naphthalene-1,3-diyl; naphthalene-1,4-diyl; naphthalene-2,3-diyl; phenol-2,3-diyl; phenol-2,4-diyl; phenol-2,5-diyl or phenol-2,-6-diyl,

heteroaryl: heterocyclic aromatic compounds such as pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl,

heteroarylene: bivalent heterocyclic aromatic compounds such as pyridin-2,3-diyl; pyridin-2,4-diyl; pyridin-2,5-diyl; pyridin-2,6-diyl; pyridin-3,4-diyl; pyridin-3,5-diyl; quinolin-2,3-diyl; quinolin-2,4-diyl; quinolin-2,8-diyl; isoquinolin-1,3-diyl; isoquinolin-1,4-diyl; pyrazol-1,3-diyl; pyrazol-3,5-diyl; triazole-3,5-diyl; triazole-1,3-diyl; pyrazin-2,5-diyl; or imidazole-2,4-diyl,

heterocycloalkyl: C₁-C₆-heterocycloalkyl, wherein the heterocycloalkyl of the —C₁-C₆-heterocycloalkyl may be selected from the group consisting of pyrrolinyl; pyrrolidinyl; morpholinyl; piperidinyl; piperazinyl; hexamethylene imine; and oxazolidinyl,

amine: the group —N(R)₂ wherein each R is independently selected from: hydrogen; C₁-C₆-alkyl; C₁-C₆-alkyl-C₆H₅ such as benzyl; and phenyl, wherein when both R are C₁-C₆-alkyl both R together may form an —NC₃ to an —NC₅ heterocyclic ring with any remaining alkyl chain forming an alkyl substituent to the heterocyclic ring,

halogen: selected from the group consisting of: F; Cl; Br and I,

perhalogen: selected from the group consisting of C₁-C₆ linear and branched alkyls, C₁-C₆ alkylenes, aryls, alkenyls, arylenes, heteroaryl, heteroarylenes, heterocycloalkyl, alkynyls, alkynylenes, conjugated polyenes, C₃-C₈-cycloalkyl, carbonyl derivatives and C₁-C₆-alkyl-C₆H₅ such as benzyl, which are partially or fully substituted by halogens such as for example CH₂F, CHF₂, CF₃, CH₂Cl, CHCl₂, CCl₃, CF₂, CCl₂, CHF, CHCl, chlorofluoromethyl; dichlorofluoromethyl; chlorodifluoromethyl; 2-fluoroethyl; 2-chloroethyl; 2-bromoethyl; 2-iodoethyl; 2,2-difluoroethyl; 2,2,2-trifluoroethyl; 2-chloro-2-fluoroethyl; 2-chloro-2,2-difluoroethyl; 2,2-dichloro-2-fluoroethyl; 2,2,2-trichloroethyl; C₂F₅; C₆H₄F; C₆H₃F₂; C₆F₅; CF₃C(O); 2-chloroallyl; 3-chloroallyl; 2,3-dichloroallyl; 3,3-dichloroallyl; 2,3,3-trichloroallyl; 2,3-dichlorobut-2-enyl; 3-chloropropargyl; 3-bromopropargyl; 3-fluoropropargyl; 3,3,3-trifluoropropargyl,

sulphonate: the group —S(O)₂OR, wherein R is selected from: hydrogen; C₁-C₆-alkyl; arylyl; C₁-C₆-alkyl-C₆H₅; Li; Na; K; Cs; Mg; and Ca,

sulphate: the group —OS(O)₂OR, wherein R may be selected from: hydrogen; C₁-C₆-alkyl; aryl; C₁-C₆-alkyl-C₆HS; Li; Na; K; Cs; Mg; and Ca,

sulphone: the group —S(O)₂R, wherein R may be selected from: hydrogen; C₁-C₆-alkyl; aryl; C₁-C₆-alkyl-C₆H₅ and amine (to give sulphonamide) selected from the group: —NR′₂, wherein each R′ is independently selected from: hydrogen; C₁-C₆-alkyl; C₁-C₆-alkyl-C₆H₅; and aryl, wherein when both R′ are C₁-C₆-alkyl both R′ together may form an —NC₃ to an —NC₅ heterocyclic ring with any remaining alkyl chain forming an alkyl substituent to the heterocyclic ring,

carboxylate derivative: the group —C(O)OR, wherein R may be selected from: hydrogen; C₁-C₆-alkyl; aryl; C₁-C₆-alkyl-C₆H₅; Li; Na; K; Cs; Mg; and Ca,

carbonyl derivative: the group —C(O)R, wherein R may be selected from: hydrogen; C₁-C₆-alkyl such as methoxy; ethoxy; n-propoxy; iso-propoxy; n-butoxy; 1-methylpropoxy; 2-methylpropoxy; n-pentoxy; 1-methylbutoxy; 2-methylbutoxy; 3-methylbutoxy; 1,1-dimethylpropoxy; 1,2-dimethylpropoxy; 2,2-dimethylpropoxy; 1-ethylpropoxy; n-hexoxy; 1-methylpentoxy; 2-methylpentoxy; 3-methylpentoxy; 4-methylpentoxy; 1,1-dimethylbutoxy; 1,2-dimethylbutoxy; 1,3-dimethylbutoxy; 2,2-dimethylbutoxy; 2,3-dimethylbutoxy; 3,3-dimethylbutoxy; 2-ethylbutoxy; 2-ethylbutoxy; 1,1,2-trimethylpropoxy; 1,2,2-trimethylpropoxy; 1-ethyl-1-methylpropoxy and 1-ethyl-2-methylpropoxy; aryl; C₁-C₆-alkyl-C₆H₅ and amine (to give amide) selected from the group: —NR′₂, wherein each R′ is independently selected from: hydrogen; C₁-C₆-alkyl; C₁-C₆-alkyl-C₆H₅; and phenyl, wherein when both R′ are C₁-C₆-alkyl both R′ together may form an —NC₃ to an —NC₅ heterocyclic ring with any remaining alkyl chain forming an alkyl substituent to the heterocyclic ring,

phosphonate: the group —P(O)(OR)₂, wherein each R may be independently selected from: hydrogen; C₁-C₆-alkyl; aryl; C₁-C₆-alkyl-C₆H₅; Li; Na; K; Cs; Mg; and Ca,

phosphate: the group —OP(O)(OR)₂, wherein each R may independently selected from: hydrogen; C₁-C₆-alkyl; aryl; C₁-C₆-alkyl-C₆H₅; Li; Na; K; Cs; Mg; and Ca,

phosphine: the group —P(R)₂, wherein each R may independently selected from: hydrogen; C₁-C₆-alkyl; aryl; and C₁-C₆-alkyl-c₆H₅,

phosphine oxide: the group —P(O)R₂, wherein R may be independently selected from: hydrogen; C₁-C₆-alkyl; phenyl; and C₁-C₆-alkyl-C₆H₅; and amine (to give phosphonamidate) selected from the group: —NR′₂, wherein each R′ is independently selected from: hydrogen; C₁-C₆-alkyl; C₁-C₆-alkyl-C₆H₅; and aryl, wherein when both R′ are C₁-C₆-alkyl both R′ together may form an —NC₃ to an —NC₅ heterocyclic ring with any remaining alkyl chain forming an alkyl substituent to the heterocyclic ring.

M, Mₙ, Mₘ (n, m being an integer): metals (either charged or uncharged), whereby two Metals Mₙ and Mₘ are independently selected from each other unless otherwise indicated.

According to a further preferred embodiment of the present invention, the electroluminescent compound comprises at least one ligand bound to at least one of the metals which contains a functional group which is an hole transporting ligand.

Hole transport in layers of these substances occurs under the influence of a strong electric field, when injected holes are transferred from one molecule to an adjacent one. For this to occur, the hole-transporting groups must be donor-like in their neutral state. Conversely, for electron transport, the functional groups must be acceptor-like in their neutral state.

Preferably, the hole-transporting ligand has a general structure of formula I and/or formula II:

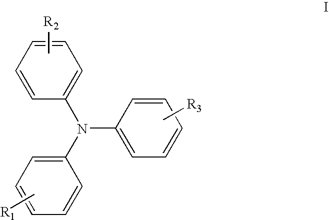

wherein R₁, R₂ and/or R₃ are independently selected out of a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine,

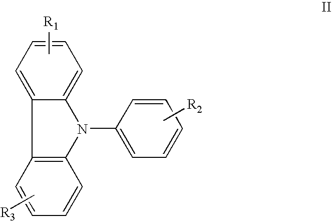

wherein R₁, R₂ and/or R₃ are independently selected out of a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine.

In a yet preferred embodiment of the present invention, the electroluminescent compound comprises at least one ligand bound and/or coordinated to at least one of the metals which is an electron transporting ligand. Preferably, the electron-transporting ligand has a general structure of formula III, IV, V or VI:

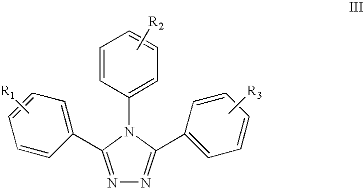

wherein R₁, R₂ and/or R₃ are selected from a group comprising hydrogen, hydroxyl, hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine,

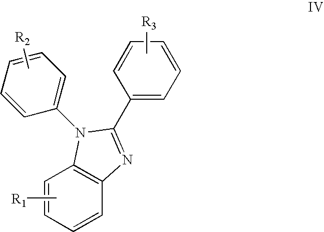

wherein R₁, R₂ and/or R₃ are independently selected from a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine,

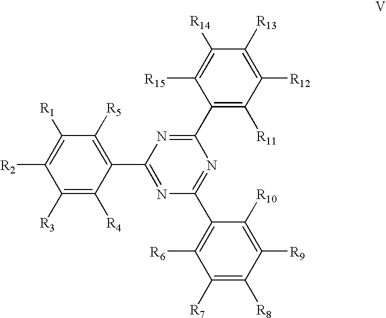

wherein R₁, R₂, R₃, R₄, R₅, R₆, R₇, R₈, R₉, R₁₀, R₁₁, R₁₂, R₁₃, R₁₄ and/or R₁₅ are independently selected from a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine,

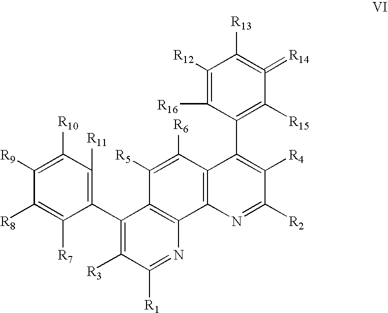

wherein R₁, R₂, R₃, R₄, R₅, R₆, R₇, R₈, R₉, R₁₀, R₁₁, R₁₂, R₁₃, R₁₄, R₁₅ and/or R₁₆ are independently selected from a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine,

Preferably, the at least one of said bridging ligands has the general structure of formula VII to XVI

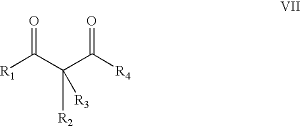

wherein R₁, R₂, R₃ and/or R₄ are independently selected from a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine,

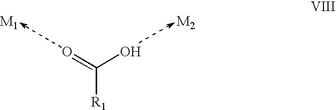

wherein R₁ is selected from a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine,

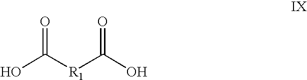

wherein R₁ is at least in the bridging part between the two carboxyl groups fully conjugated and is selected out of a group comprising arylene, heteroarylene, alkylene alkynylene, conjugated polyene, perhalogen, —CHY— and CH(CH₂)ₓY, where Y is selected out of a group comprising alkyl, aryl, heteroaryl, cycloalkyl, heterocycloalkyl, alkenyl, C₁-C₆-alkyl-C₆H₅, phosphonate, phosphate, phosphine, phosphine oxide, sulphonyl, sulphonate, sulphate, sulphone, and amine and wherein x is an integer number or zero.

It should be noted that only groups are selected from the above mentioned generic groups that allow for fully conjugation between the two carboxyl groups.

It should be noted, that certain functional groups R₁, e.g. methylene are considered fully conjugated, although usually e.g. a methylene group is considered not to be fully conjugated. The reason for this is that there can be a full conjugation by formation of tautomers:

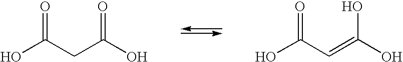

Functional groups R₁, in which a conjugation by the formation of tautomers is possible, are considered fully-conjugated in the sense of the present application, too.

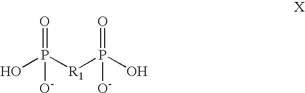

wherein R₁ is at least in the bridging part between the two phosphoryl groups fully conjugated and is selected from a group comprising arylene, heteroarylene, alkylene, alkynylene, conjugated polyene, perhalogen, —CHY— and CH(CH₂)ₓY, where Y is selected out of a group comprising alkyl, aryl, heteroaryl, cycloalkyl, heterocycloalkyl, alkenyl, C₁-C₆-alkyl-C₆H₅, phosphonate, phosphate, phosphine, phosphine oxide, sulphonyl, sulphonate, sulphate, sulphone, and amine and wherein x is an integer number or zero,

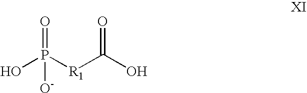

wherein R₁ is at least in the bridging part between the carboxyl group and the phosphoryl group fully conjugated and is selected from a group comprising arylene, heteroarylene, alkylene, alkynylene, conjugated polyene, perhalogen, —CHY— and CH(CH₂)ₓY, where Y is selected out of a group comprising alkyl, aryl, heteroaryl, cycloalcyl, heterocycloalkyl, alkenyl, C₁-C₆-alkyl-C₆H₅, phosphonate, phosphate, phosphine, phosphine oxide, sulphonyl, sulphonate, sulphate, sulphone, and amine and wherein x is an integer number or zero,

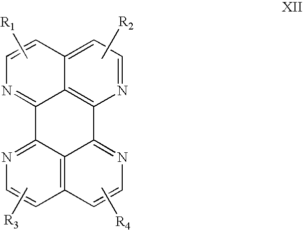

wherein R₁, R₂, R₃ and/or R₄ are independently selected out of a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine;

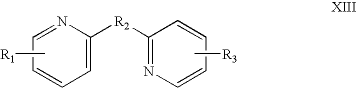

wherein R₂ is at least in the bridging part between the pyridyl groups fully conjugated and is selected out of a group comprising arylene, heteroarylene, alkylene, alkynylene, conjugated polyene, perhalogen, wherein R₁ and/or R₃ are independently selected out of a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate; phosphine, phosphine oxide, sulphonyl, sulphonate, sulphate, sulphone, and amine

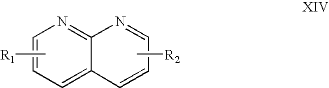

wherein R₁ and/or R₂ are independently selected out of a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine and wherein R₁ and R₂ are different or identical,

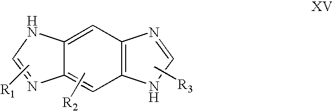

wherein R₁, R₂ and/or R₃ are independently selected out of a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine,

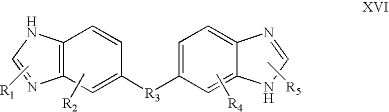

wherein R₃ is at least in the bridging part between the benzimidazolyl groups fully conjugated and is selected from a group comprising arylene, heteroarylene, alkylene, alkynylene, conjugated polyene, perhalogen, wherein R₁, R₂, R₄ and R₅ are independently selected out of a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine.

For the bridging substituents R in compounds X, XI, XIII and XVI it should be noted that only groups are selected from the above mentioned generic groups that allow for fully conjugation between the two functional groups (phosphate groups in compound X, phosphate group and carboxyl group in compound XI, pyridyl groups in compound XIII and benzimidazolyl groups in compound XVI).

A preferred electroluminescent device according to the present invention comprises sequentially at least one first electrode, at least one layer of an electroluminescent compound as described above and at least one second electrode. For the first and second electrode, all electrodes as well as all electrode materials known in the art can be used.

For a better build-up of such an electroluminescent device, it is preferred, that the electroluminescent compound is electrically neutral. This can e.g. achieved in that charged ligands are used to compensate for the metal ion charges. By using a neutrally-charged electroluminescent compound, the electroluminescent compound can be build up by vapor deposition.

Preferably, the thickness of the at least one layer of the electroluminescent compound is between >0 and ≦1000 Å, more preferably between ≧5 and ≦700 Å, more preferably between ≧20 and ≦500 Å, more preferably between ≧50 and ≦250 Å, and most preferably between ≧100 and ≦150 Å,

The concentration of electroluminescent compound present in the layer of the electroluminescent compound is in wt % of the total weight of the layer of the electroluminescent compound preferably between >0 and ≦100% (wt %), more preferably between ≧10 and ≦99% (wt %), more preferably between ≧20 and ≦98% (wt %), more preferably between ≧30 and ≦97% (wt %), and most preferably between ≧50 and ≦95% (wt %).

The concentration of metal atoms present in the layer of the electroluminescent compound is in wt % of the total weight of the layer of the electroluminescent compound preferably between ≧5 and ≦50% (wt %), more preferably between ≧10 and ≦45% (wt %), more preferably between ≧15 and ≦40% (wt %), and most preferably between ≧20 and ≦30% (wt %).

A preferred lighting unit according to the present invention contains an electroluminescent device as described above and can be used in household applications, shop lighting, home lighting, accent lighting, spot lighting, theater lighting, fiber-optics applications, projection systems, self-lit displays, medical lighting applications, pixelated displays, segmented displays, warning signs, indicator signs, decorative lighting, etc.

1. An electroluminescent compound selected from binuclear, trinuclear, oligonuclear, and/or polynuclear complexes of metals comprising at least one bridging ligand which is bound and/or coordinated to at least two of said metals, whereby at least one of said ligands is fully-conjugated at least between the binding and/or coordination sites of said metals.

2. An electroluminescent compound according to claim 1, in which the metals are rare earth metals, preferably selected from the group comprising La, Ce, Pr, Nd, Pm, Sm, Eu, Gd, Tb, Dy, Ho, Er, Tm, Yb, Lu.

3. An electroluminescent compound according to claim 1, in which the metals are the same.

4. An electroluminescent compound according to claim 1 in which the electroluminescent compound comprises at least one ligand bound to at least one of the metals which contains a functional group which is an hole transporting ligand.

5. An electroluminescent compound according to claim 4, where the hole-transporting functional group having a general structure of formula I and/or formula II: 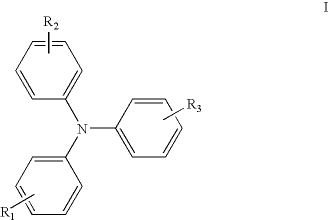
wherein R₁, R₂ and/or R₃ are independently selected out of a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine. 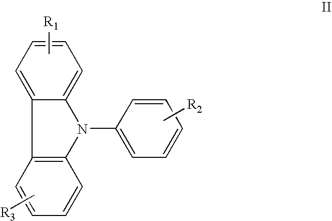
wherein R₁, R₂ and/or R₃ are independently selected out of a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine.

6. An electroluminescent compound according to claim 1 in which the electroluminescent compound comprises at least one ligand bound and/or coordinated to at least one of the metals (M₁ . . . Mₙ) which is an electron transporting ligand

7. An electroluminescent compound according to claim 6, where the electron-transporting ligand has a general structure of formula III, IV, V or VI: 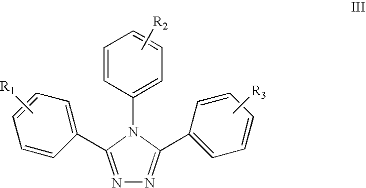
hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine 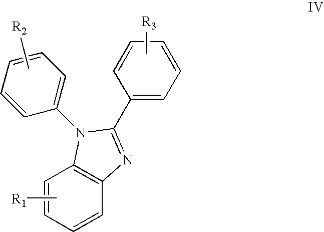
wherein R₁, R₂ and/or R₃ are independently selected from a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine, 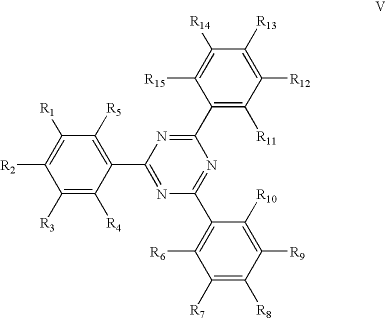
wherein R₁, R₂, R₃, R₄, R₅, R₆, R₇, R₈, R₉, R₁₀, R₁₁, R₁₂, R₁₃, R₁₄ and/or R₁₅ are independently selected from a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine, 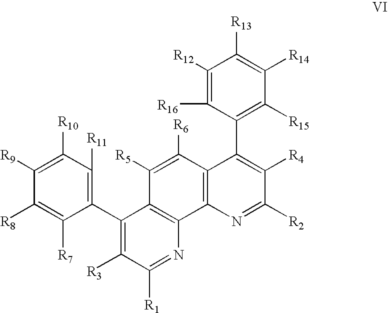
wherein R₁, R₂, R₃, R₄, R₅, R₆, R₇, R₈, R₉, R₁₀, R₁₁, R₁₂, R₁₃, R₁₄, R₁₅ and/or R₁₆ are independently selected from a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine.

8. An electroluminescent compound according to claim 1, wherein at least one of said bridging ligands having the general structure of formula VII to XVI 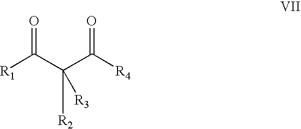
wherein R₁, R₂, R₃ and/or R₄ are independently selected from a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine, 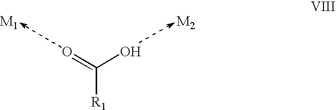
wherein R₁ is selected from a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine; 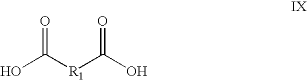
wherein R₁ is at least in the bridging part between the two carboxyl groups fully conjugated and is selected out of a group comprising arylene, heteroarylene, alkylene, alkynylene, conjugated polyene, perhalogen, —CHY— and CH(CH₂)ₓY, where Y is selected out of a group comprising alkyl, aryl, heteroaryl, cycloalkyl, heterocycloalkyl, alkenyl, C₁-C₆-alkyl-C₆H₅, phosphonate, phosphate, phosphine, phosphine oxide, sulphonyl, sulphonate, sulphate, sulphone, and amine and wherein x is an integer number or zero, 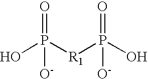
wherein R₁ is at least in the bridging part between the two phosphoryl groups fully conjugated and is selected from a group comprising arylene, heteroarylene, alkylene, alkynylene, conjugated polyene, perhalogen, —CHY— and CH(CH₂)ₓY, where Y is selected out of a group comprising alkyl, aryl, heteroaryl, cycloalkyl, heterocycloalkyl, alkenyl, C₁-C₆-alkyl-C₆H₅, phosphonate, phosphate, phosphine, phosphine oxide, sulphonyl, sulphonate, sulphate, sulphone, and amine and wherein x is an integer number or zero, 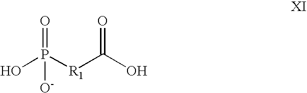
wherein R₁ is at least in the bridging part between the carboxyl group and the phosphoryl group fully conjugated and is selected from a group comprising arylene, heteroarylene, alkylene, alkynylene, conjugated polyene, perhalogen, —CHY— and CH(CH₂)ₓY, where Y is selected out of a group comprising alkyl, aryl, heteroaryl, cycloalkyl, heterocycloalkyl, alkenyl, C₁-C₆-alkyl-C₆H₅, phosphonate, phosphate, phosphine, phosphine oxide, sulphonyl, sulphonate, sulphate, sulphone, and amine and wherein x is an integer number or zero, 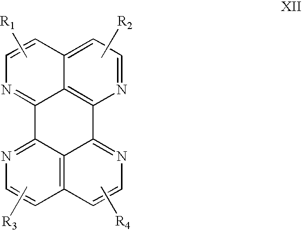
wherein R₁, R₂, R₃ and/or R₄ are independently selected out of a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine; 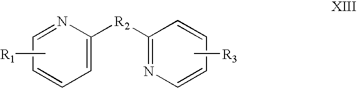
wherein R₂ is at least in the bridging part between the pyridyl groups fully conjugated and is absent or selected out of a group comprising arylene, heteroarylene, alkylene, alkynylene, conjugated polyene, perhalogen, wherein R₁ and R₃ are selected out of a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine. 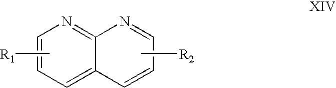
wherein R₁ and/or R₂ are independently selected out of a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine, 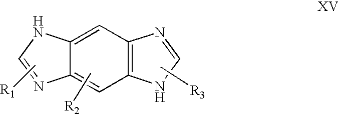
wherein R₁, R₂ and/or R₃ are independently selected out of a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine, 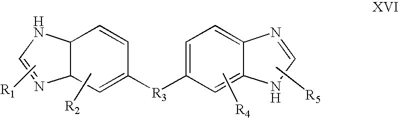
wherein R₃ is at least in the bridging part between the benzimidazol groups fully conjugated and is absent or selected from a group comprising, arylene, heteroarylene, alkylene, alkynylene, conjugated polyene, perhalogen, wherein R₁, R₂, R₄ and/or R₅ are independently selected out of a group comprising hydrogen, hydroxyl, halogen, perhalogen, carboxylate- and/or carbonyl derivatives, alkyl, cycloalkyl, aryl, arylene-containing substituents, heteroaryl, heteroarylene-containing substituents, heterocycloalkyl, alkenyl, alkylene-containing substituents, alkinyl, alkynylene-containing substituents, phosphonate, phosphate, phosphine, phosphine oxide, sulphonyl, sulphonate, sulphate, sulphone, and amine.

9. An electroluminescent device which comprises sequentially at least one first electrode, at least one layer of an electroluminescent compound and at least one second electrode whereby the at least one electroluminescent compound is selected according to claim 1.

10. A lighting unit comprising an electroluminescent device according to claim 9 for the use in household applications, shop lighting, home lighting, accent lighting, spot lighting, theater lighting, fiber-optics applications, projection systems, self-lit displays, pixelated displays, segmented displays, warning signs, medical lighting applications, indicator signs, and decorative lighting.
